(19) United States
(12) Patent Application Publication
(10) Pub. No.: US 2025/0037959 A1
(43) Pub. Date: Jan. 30, 2025

(54) LARGE ELECTRON TUBE, MAGNETIC BODY, AND METHOD FOR USING LARGE ELECTRON TUBE

(71) Applicant: NATIONAL INSTITUTES FOR QUANTUM SCIENCE AND TECHNOLOGY, Chiba (JP)

(72) Inventors: Takahiro SHINYA, Chiba (JP); Ryosuke IKEDA, Chiba (JP); Takayuki KOBAYASHI, Chiba (JP)

(21) Appl. No.: 18/710,873

(22) PCT Filed: Nov. 16, 2022
(86) PCT No.: PCT/JP2022/042577

§ 371 Date: May 16, 2024

(30) Foreign Application Priority Data
Nov. 19, 2021 (JP) 2021-188962

(51) Int. Cl. H01J 23/11; H01J 23/027; H01J 23/075; H01J 23/10; H01J 25/02; H01J 25/10

(52) U.S. Cl. CPC H01J 23/11; H01J 23/027; H01J 23/075; H01J 23/10; H01J 25/025; H01J 25/10

(57) ABSTRACT

A large electron tube includes: a tubular collector; and a magnetic body disposed outside the collector and having no axial symmetry with respect to a center axis of the collector. This makes it possible to inhibit parasitic oscillation that occurs inside the collector.

### TECHNICAL FIELD

The present invention relates to a large electron tube. Further, the present invention relates to a magnetic body to be mounted to the large electron tube. Further, the present invention relates to a method of using the large electron tube.

### BACKGROUND ART

Large electron tubes of various types, such as a gyrotron and a klystron have been put to practical use. For example, a high-power, long-pulse, and highly-efficient gyrotron has been developed for fusion plasma. Studies have also been made to use a gyrotron as a power source for propelling a rocket or as an electric power source for remotely charging a rocket. Further, klystrons are used as an electric power source for various accelerators. Patent Literature 1 is an example of literature disclosing a gyrotron for fusion plasma.

### CITATION LIST

### Patent Literature

[Patent Literature 1]
Japanese Patent Application Publication, Tokukaihei, No. 4-351836

### SUMMARY OF INVENTION

### Technical Problem

It is an object of an aspect of the present invention to inhibit parasitic oscillation that occurs in a tubular collector of a large electron tube.

### Solution to Problem

A large electron tube in accordance with an aspect of the present invention is a large electron tube, including: a collector that is tubular (for example, cylindrical); and a magnetic body disposed outside the collector and having no axial symmetry with respect to a center axis of the collector.

### Advantageous Effects of Invention

According to an aspect of the present invention, it is possible to inhibit parasitic oscillation that occurs in a large electron tube (for example, a gyrotron device for fusion plasma).

### BRIEF DESCRIPTION OF DRAWINGS

FIG. 1 is a view illustrating an overview of an Example of the present invention, the view illustrating a line of magnetic force (≃ a center of an orbit of an electron beam) from an electron gun to a collector of an ITER gyrotron. The five curves illustrated in FIG. 1 represent lines of magnetic force which, from left to right, respectively corresponding to collector coil currents of 0 A, 5 A, 10 A, 15 A, and 20 A.

FIG. 2 is a view illustrating an overview of an Example of the present invention, the view illustrating a frequency of RF noise measured when a collector coil current is swept (586 MHz is of background noise).

FIG. 3 is a view illustrating details of the Example of the present invention and pertains to a structure of an ITER gyrotron.

FIG. 4 is a view illustrating details of the Example of the present invention and pertains to a device for measuring high-frequency noise and a result of measurement carried out during a long pulse operation.

FIG. 5 is a view illustrating details of the Example of the present invention and pertains to a result of measurement carried out during a short pulse operation.

FIG. 6 is a view illustrating details of the Example of the present invention and pertains to a resonant frequency of a collector.

FIG. 7 is a view illustrating details of the Example of the present invention and pertains to a consideration of a mechanism by which high-frequency noise is generated.

FIG. 8 is a view illustrating details of the Example of the present invention and pertains to inhibition of high-frequency noise with use of a magnetic body.

FIG. 9 is a view illustrating details of the Example of the present invention and pertains to an effect of a magnetic shield (magnetic body) of an ion pump on generation of high-frequency noise.

FIG. 10 is a view illustrating details of the Example of the present invention and pertains to an example of application to a gyrotron for JT-60SA (138 GHZ).

FIG. 11 is a view illustrating a large electron tube in accordance with an embodiment of the present invention. (a) of FIG. 11 is a longitudinal sectional view of the large electron tube, and (b) of FIG. 11 is a transverse sectional view of the large electron tube.

### DESCRIPTION OF EMBODIMENTS

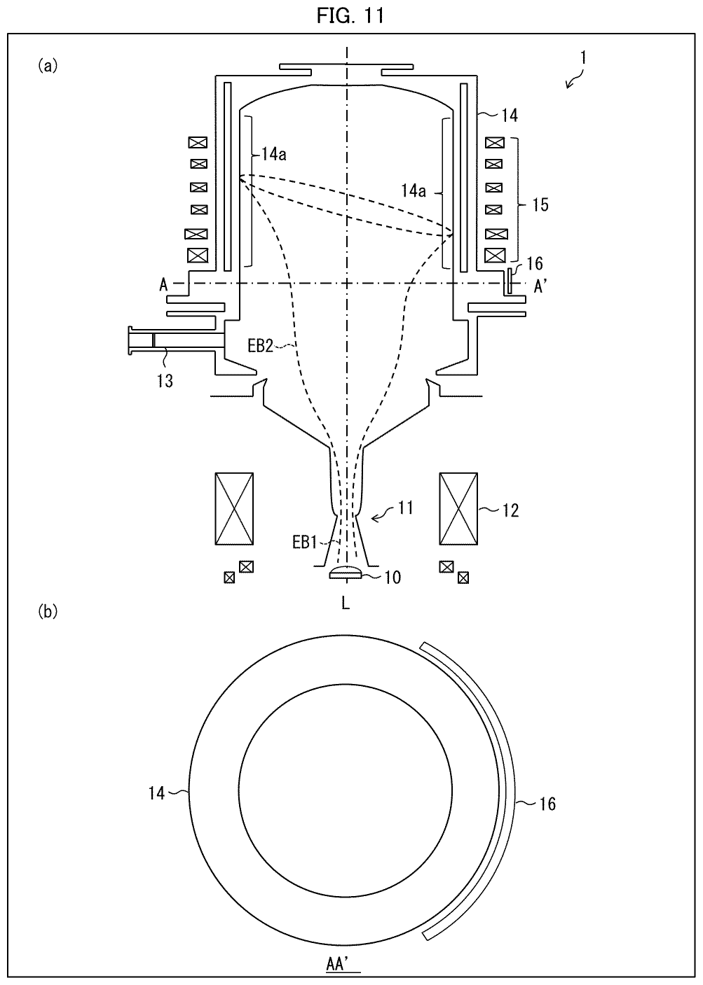

With reference to FIG. 11, the following description will discuss a large electron tube 1 in accordance with an embodiment of the present invention. In FIG. 11, (a) is a longitudinal sectional view of the large electron tube 1, and (b) is a transverse sectional view of the large electron tube 1. The transverse section illustrated in (b) of FIG. 11 is a cross section, taken along line A-A′, of the large electron tube 1 illustrated in (a) of FIG. 11. The large electron tube 1 in accordance with the present embodiment is a gyrotron.

The large electron tube 1 includes a magnetron electronic gun 10, a tubular (in the present embodiment, cylindrical) resonator 11, and a superconducting coil 12 surrounding the resonator 11 from outside. The magnetron electronic gun 10 generates a hollow electron beam EB1. Of the energy of the hollow electron beam EB1, energy in a direction orthogonal to a line of magnetic force formed in the superconducting coil 12 is converted into energy of a millimeter wave of a TE mode inside the resonator 11, due to a cyclotron resonance maser action. The millimeter wave of the TE mode is converted into a Gaussian beam by a mode converter and a mirror, and is outputted to the outside through an output window 13.

The large electron tube 1 includes a tubular (in the present embodiment, cylindrical) collector 14, and a collector coil 15 surrounding the collector 14 from outside. The hollow electron beam EB1 that has passed through the resonator 11, that is, a spent electron beam EB2 collides against an inner side surface of the collector 14, so that the energy of the spent electron beam EB2 is recovered. The collector coil 15 functions as a sweep mechanism that sweeps a line of magnetic force inside the collector 14 to thereby change a position where the spent electron beam EB2 collides on the inner side surface of the collector 14.

In the collector 14 of the large electron tube 1, parasitic oscillation may occur. For example, in a case where a resonant frequency of the collector 14 satisfies a condition for cyclotron resonance, such parasitic oscillation may occur.

In order to inhibit such parasitic oscillation, the large electron tube 1 includes a magnetic body 16 disposed outside the collector 14. The magnetic body 16 does not have axial symmetry with respect to a center axis L of the collector 14. The provision of such a magnetic body 16 makes it possible to spread the spent electron beam EB2 asymmetrically. This prevents an oscillation condition for parasitic oscillation (for example, the above-described condition for cyclotron resonance) from being satisfied and, as a result, makes it possible to inhibit parasitic oscillation.

The magnetic body 16 is preferably designed such that the spent electron beam EB2 inside the collector 14 collides against a water-cooled part 14a of the collector 14. This makes it possible to inhibit the collector 14 from being overheated by collision of the spent electron beam EB2 and consequently having an excessively increased temperature.

In the present embodiment, the magnetic body 16 is a plate-like magnetic body which is disposed along an outer side surface of the collector 14 and covers not more than ½ of an outer circumference of the collector 14. This makes it possible to easily add, to the large electron tube 1, a mechanism for inhibiting parasitic oscillation. Further, in the present embodiment, an iron plate is used as the magnetic body 16. This makes it possible to inexpensively add, to the large electron tube 1, a mechanism for inhibiting parasitic oscillation. Note that the magnetic body 16 can be a single magnetic body plate (e.g., an iron plate) that is curved along the outer side surface of the collector 14, or can be a plurality of magnetic body plates (e.g., iron plates) that are disposed along the outer side surface of the collector 14. In the latter case, each of the magnetic body plates can be a flat plate-like magnetic body plate that is not curved. In the former case, for example, by changing a size of the magnetic body plate, it is possible to change a ratio at which the magnetic body 16 covers the outer circumference of the collector 14. Further, in the latter case, for example, by changing the number of the magnetic body plates, it is possible to change a ratio at which the magnetic body 16 covers the outer circumference of the collector 14.

Note that the scope of application of the present invention is not limited to a gyrotron. That is, the present invention can also be applied to a large electron tube other than a gyrotron, such as a klystron.

### EXAMPLES

### Overview

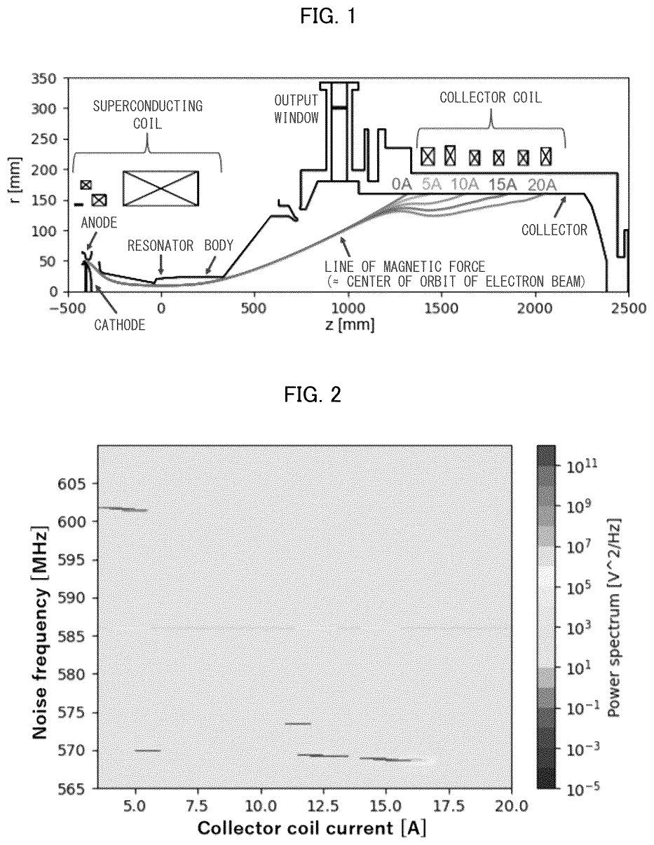

A high-power, long-pulse, and highly-efficient gyrotron developed for fusion plasma operates as follows (see FIG. 1). i) An electron gun generates an annular-shaped electron beam. ii) Magnetic compression is carried out in an external magnetic field. iii) In a cylindrical resonator, energy in a direction perpendicular to a line of magnetic force is converted into energy of a millimeter wave by a cyclotron resonance maser action. iv) With a mode converter and a mirror, a millimeter wave of a high-order TE mode is converted into a Gaussian beam and emitted through an output window. v) Meanwhile, a part of energy of a spent electron beam that has passed through the resonator (CPD) is recovered at a power supply. vi) The remaining energy of the spent electron beam is recovered at a collector. A point to be noted in designing the gyrotron is not to cause oscillation (parasitic oscillation) anywhere other than the resonator in this process. For example, previous research has found that, in order to avoid parasitic oscillation in the process ii, it is effective that an electrode has a shape that is tapered up to the resonator and it is also effective that an absorber made of a silicon carbide material or the like is inserted. It seemed that all kinds of parasitic oscillation in the gyrotron had been discovered. However, during operation of a gyrotron for ITER and a gyrotron for JT-60SA (170 GHz, 138 GHz), a measurement device detected disturbance of a signal due to noise, only for approximately 1 second to 2 seconds immediately after oscillation. This suggests a possible existence of an unknown parasitic oscillation. The generation of the noise, though not causing a deterioration in performance of the gyrotrons, would tremendously affect the measurement device, and it was therefore urgent to inhibit the generation of the noise. Thus, an investigation was carried out.

First, a single winding of a magnetic probe was installed in an atmosphere in the vicinity of the ITER gyrotron to measure a frequency of noise. As a result, high-frequency (RF) noise of approximately 570 MHz and high-frequency (RF) noise of approximately 600 MHZ were observed (see FIG. 2). Further, it was found that whether or not the RF noise was generated depended on a collector coil current for sweeping a collision position of a spent electron beam (see FIGS. 1 and 2). As such, a resonant frequency of the collector was calculated, and the calculation found that the resonant frequency was approximately 570 MHz for a TE_{1,1,2} mode and approximately 600 MHz for a TE_{1,1,3} mode. Since these resonant frequencies coincided with the measured frequencies of the RF noise, it became clear that there was a possibility that the collector was functioning as a resonator and generating the RF noise. It was also found that no RF noise was generated when the energy of the electron beam in the collector was decreased. This is considered to be a phenomenon suggesting that oscillation occurs at the collector through some kind of mechanism. As to inhibition of RF noise, the inventors of the present invention sought for a method requiring no design change. Specifically, the inventors considered that an oscillation condition can be prohibited from being satisfied by disturbing only a part of an orbit of the spent electron beam in the collector from outside with use of a magnetic body. Based on this idea, the inventors adjusted a size and an installation position of an iron plate. As a result, by installation of a specific magnetic body, RF noise was successfully inhibited without unevenness in a distribution of heat load to the collector.

### (Details)

### 1. Parasitic Oscillation

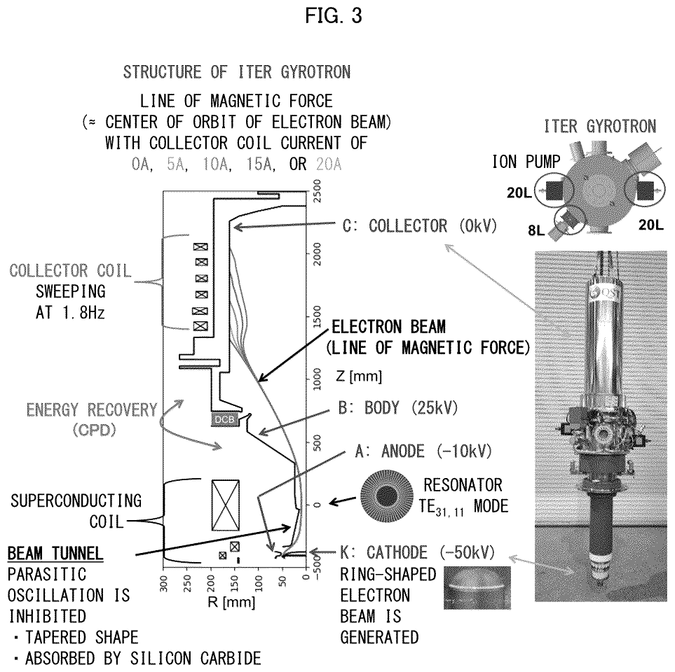

The following description will discuss parasitic oscillation with reference to FIG. 3.

A point to be noted in designing a high-power, long-pulse, and highly-efficient gyrotron is not to cause oscillation (parasitic oscillation) anywhere other than the resonator. It seemed that all kinds of parasitic oscillation in the gyrotron had been discovered. However, during operation of an ITER gyrotron (170 GHz), a measurement device detected disturbance of a signal due to noise, only for approximately 1 second to 2 seconds immediately after oscillation. This suggests a possible existence of an unknown parasitic oscillation. Since the generation of the noise would tremendously affect the measurement device, it was essential to inhibit the generation of the noise. Thus, an investigation was carried out. Note that parasitic oscillation such as the one described above may be generated not just immediately after oscillation, in a case where the oscillation efficiency is poor and also in a case where the oscillation efficiency is good but an oscillation condition is satisfied for some reason. In particular, immediately after oscillation, the oscillation efficiency tends to be poor and such parasitic oscillation is therefore likely to occur.

### 2. Device for Measuring High-Frequency Noise and Result of Measurement During Long Pulse Operation

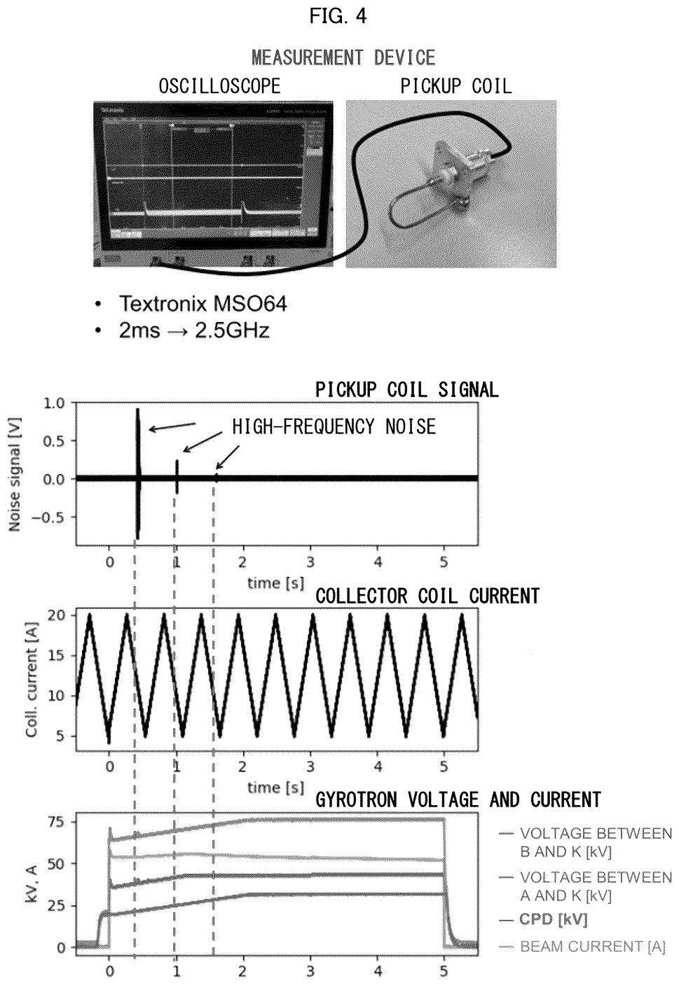

The following description will discuss, with reference to FIG. 4, a device for measuring high-frequency noise and a result of measurement carried out during a long pulse operation.

A single winding of a pickup coil was installed on an atmosphere side in the vicinity of the gyrotron, and signals were directly measured with a high-time resolution oscilloscope. As a result, high-frequency noise of approximately 570 MHz was detected only for approximately 1 second to 2 seconds after oscillation. From this, it was found that whether or not noise was generated was related to a collector coil current and an applied voltage.

### 3. Result of Measurement During Short Pulse Operation

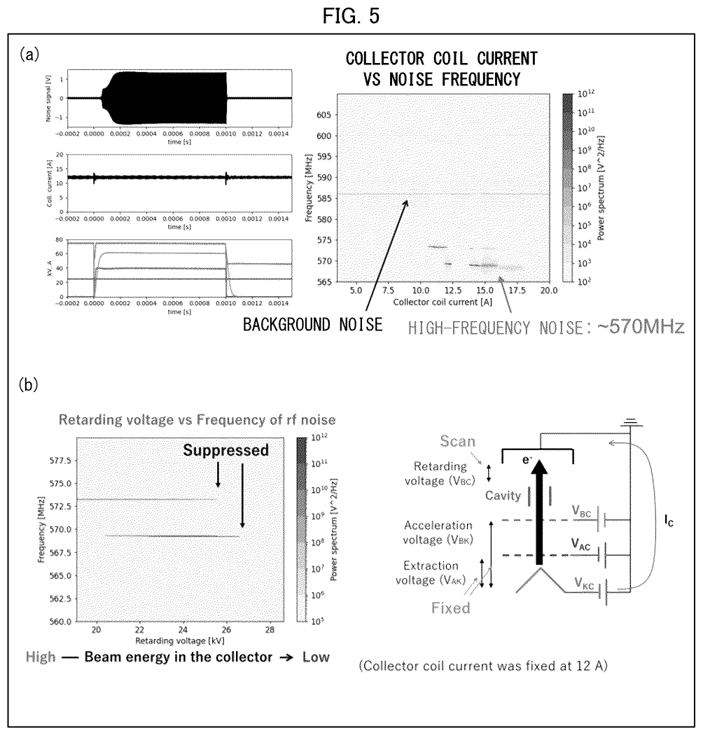

The following description will discuss, with reference to FIG. 5, a result of measurement carried out during a short pulse operation.

The collector coil current was fixed at a short pulse (1 ms), and a frequency of noise was measured while the collector coil current was swept for each shot. As a result, as shown in a graph on the right side of (a) of FIG. 5, high-frequency noise of approximately 570 MHz was observed at 11 A to 18 A. Further, as shown in a graph on the left side of (b) of FIG. 5, when the CPD was raised from 25 kV to 29 kV, no high-frequency noise was generated.

### 4. Resonant Frequency of Collector

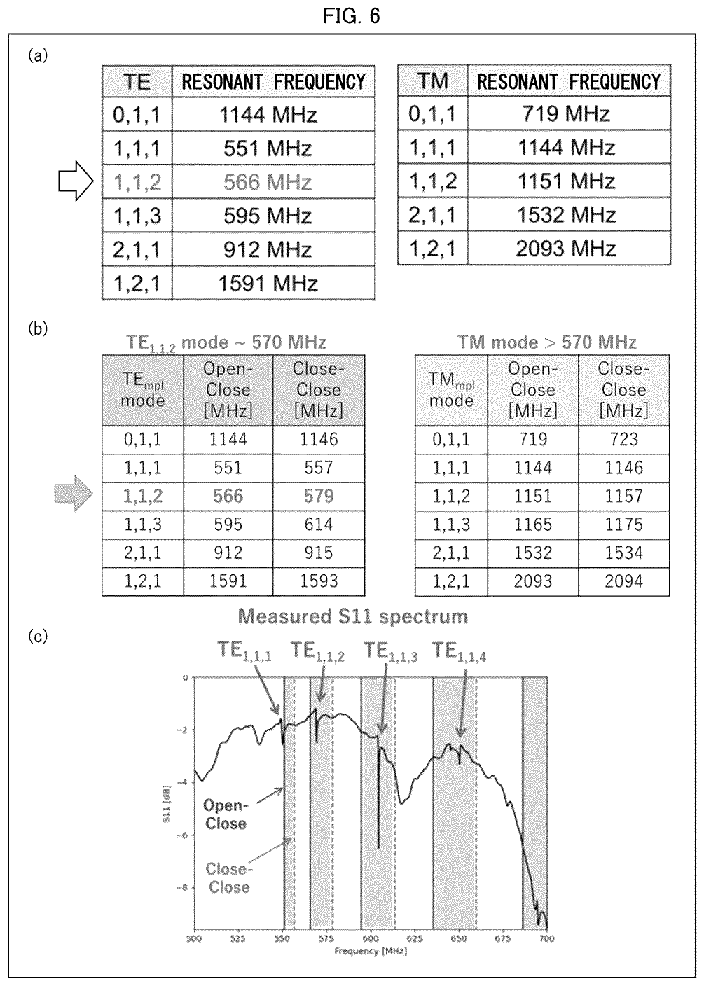

The following description will discuss, with reference to FIG. 6, a resonant frequency of the collector.

The resonant frequency of the collector was calculated by an expression below. As shown in (a) of FIG. 6, the resonant frequency was approximately 570 MHz for a TE_{1,1,2} mode. Further, when an S11 spectrum was measured with use of a loop antenna and a network analyzer, a graph shown in (c) of FIG. 6 was obtained. Since the resonant frequencies calculated by the expression below coincided with the measured frequencies of the high-frequency noise, it was confirmed that there was a high possibility that the collector functioned as a resonator and generated RF noise.

Resonance frequency of cylinder with its one end open (Open-Close):

$$f = \frac{c}{2 π} \sqrt{{{( \frac{{X}_{mp}}{R} )}^{2} + [ \frac{π}{L} ( l - \frac{1}{2} \} ]}^{2}}$$

$${TE}_{mpl} mod \text{e:} {x}_{mp} = \frac{{j}_{mp}^{′}}{R} , {TM}_{mpl} mode : {x}_{mp} = \frac{{j}_{mp}}{R}$$

jₘₚ: p-th zero of m-th order Bessel function.
jₘₚ′: p-th zero of derivative of m-th order Bessel function.
m, p, l: The number of modes in rotation direction, radial direction, and axial direction.
R: Radius of cavity [m]=0.16 m.
L: Length of cavity [m]=1.64 m.
Capacitance between collector and body etc. are not taken into consideration.

Further, a resonant frequency of the collector was calculated by an expression below for each of a case with an open-close setting and a case with a close-close setting. As shown in (b) of FIG. 6, the resonant frequency was calculated to be approximately 570 MHz for a TE_{1,1,2} mode in both cases. Since the resonant frequencies calculated by the expression below also coincided with the measured frequencies of the high-frequency noise (see (c) of FIG. 6), it was reconfirmed that there was a high possibility that the collector was functioning as a resonator and generating RF noise.

$$Open - Close \text{:} f = \frac{c}{2 π} \sqrt{{( \frac{{X}_{mp}}{R} )}^{2} + {[ \frac{π}{L} ( l - \frac{1}{2} ) ]}^{2}}$$

$$Close - \text{Close:} f = \frac{c}{2 π} \sqrt{{( \frac{{X}_{mp}}{R} )}^{2} + {( \frac{π}{L} l )}^{2}}$$

$${TE}_{mpl} mod \text{e:} {x}_{mp} = \frac{{j}_{mp}^{′}}{R} , {TM}_{mpl} mod \text{e:} {x}_{mp} = \frac{{j}_{mp}}{R}$$

$$R = 0.16 m$$

$$L = 1.64 m$$

### 5. Consideration of Mechanism of High-Frequency Noise Generation

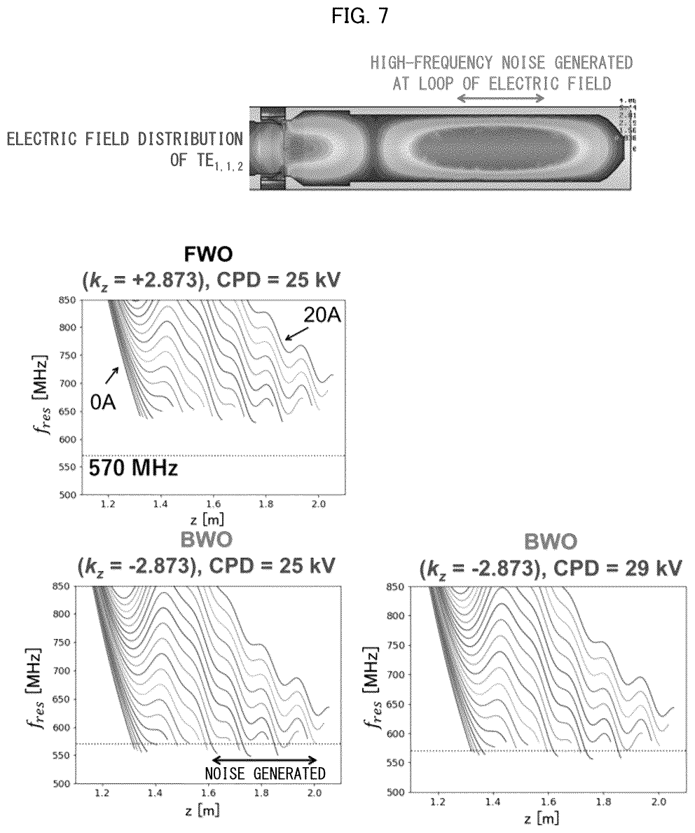

The following description will discuss, with reference to FIG. 7, a mechanism by which high-frequency noise is generated.

The inventors inferred that a cause of the generation of high-frequency noise was that oscillation of an electron beam in the collector due to a cyclotron resonance maser action caused leakage of high-frequency noise of approximately 570 MHz into the atmosphere. The reasons for this inference include the following points.

$${f}_{res} = \frac{{f}_{ce}}{γ} + \frac{{k}_{z} {v}_{z}}{2 π}$$

Oscillation condition of high-frequency noise:
   f_{c,e}: Electron cyclotron frequency, γ: Lorentz factor,

$${k}_{z} = \pm [ \frac{π}{L} ( l - \frac{1}{2} ) ] ,$$

ν₂: Speed of electron in z-direction
In the case of backward-wave oscillation (BWO), an oscillation condition of TE_{1,1,2} is satisfied.
As with the measurement result, there was a tendency that TE_{1,1,2} does not satisfy the oscillation condition when the CPD was increased.
An orbit of an electron in which the high-frequency noise has been generated satisfies the oscillating condition at a loop position where an electric field of TE_{1,1,2} is maximized.

### 6. Inhibition of High-Frequency Noise Using Magnetic Body

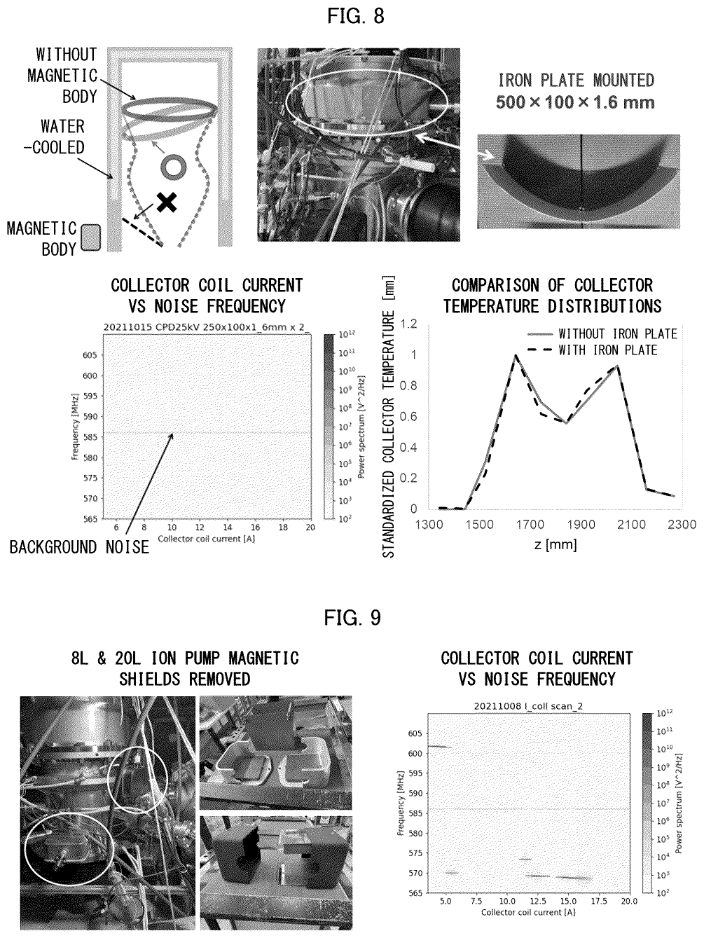

The following description will discuss inhibition of high-frequency noise with use of a magnetic body, with reference to FIG. 8.

As a method of inhibiting high-frequency noise, the inventors of the present invention sought for a method requiring no design change. If a proportion of an electron beam that satisfies the oscillation condition can be reduced by disturbing a part of beam orbits in the collector, there is a possibility that oscillation can be inhibited. As such, the inventors of the present invention devised a technique of spreading a line of magnetic force outward with use of a magnetic body from outside of the collector. As a result of adjusting a size and a position of the iron plate, the high-frequency noise was successfully inhibited. Further, a temperature distribution of the collector was measured, and it was confirmed that a collision position of the electron beam was in the cooled part.

### 7. Effect of Magnetic Shield (Magnetic Body) of Ion Pump on Generation of High-Frequency Noise

The following description will discuss, with reference to FIG. 9, an effect of a magnetic shield (magnetic body) of an ion pump on generation of high-frequency noise.

Measurement of high-frequency noise was carried out in a state where respective magnetic shields of two ion pumps (8 L and 20 L) were removed. As a result, high-frequency noise of approximately 600 MHz was newly observed when the collector coil current was 4 A to 5.5 A. This frequency (600 MHZ) of the high-frequency noise coincides with the resonant frequency of the TE_{1,1,3}. From this fact, it became clear that magnetic shields of the ion pumps inhibited high-frequency noise generated at a lower part of the collector.

### 8. Recap

The present example is summarized as follows.
The measurement with use of the pickup coil made it clear that high-frequency noise of approximately 570 MHz and high-frequency noise of approximately 600 MHz were generated from the ITER gyrotron.
Since the resonant frequencies of the collector coincided with the observed frequencies, it became clear that there was a possibility that the collector was functioning as a resonator and generating RF noise.
It was found that when the CPD was increased from 25 kV to 29 kV, no high-frequency noise was generated.
High-frequency noise was successfully inhibited by mounting an iron plate having a size of 500×100×1.6 mm on an atmosphere side of the collector.

Note that, in the present example, an example of application of the present invention to a gyrotron for ITER (170 GHz) has been described, but the present invention can be applied not only to a gyrotron for ITER (170 GHz). Indeed, the inventors demonstrated that an effect of inhibiting noise of the collector could be obtained also when the present invention was applied to a gyrotron for JT-60SA (138 GHZ).

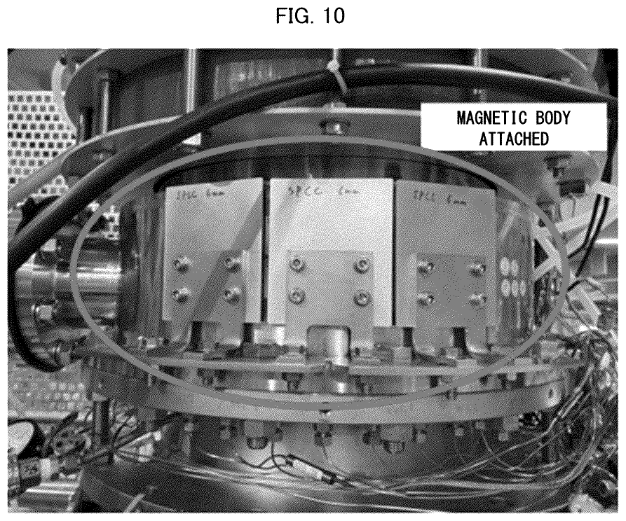

In the application of the present invention to the gyrotron for JT-60SA (138 GHZ), an iron plate (specifically, a cold-rolled steel sheet) having a length of 110 mm, a width of 110 mm, and a thickness of 6 mm was used as a magnetic body. In attaching the iron plate to the gyrotron, a technique was employed in which, first, a plurality of jigs were set to a flange of the collector, and the iron plate was screwed to the jigs. This is for making it possible to easily change the size and the number of iron plates to be used, since the size and the number of iron plates suitable for noise inhibition vary from gyrotron to gyrotron. As a result, it was confirmed that, as illustrated in FIG. 10, with the gyrotron for JT-60SA (138 GHZ), noise of the collector could be suitably reduced when three iron plates having the above-described size were used to cover 37% of the entire circumference of the collector.

### [Supplementary Note]

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1: Large electron tube
10: Magnetron electron gun
11: Resonator
12: Superconducting coil
13: Output window
14: Collector
15: Collector coil
16: Magnetic body

1. A large electron tube, comprising:
a collector that is tubular; and
a magnetic body disposed outside the collector and having no axial symmetry with respect to a center axis of the collector.

2. The large electron tube as set forth in claim 1, wherein the magnetic body is designed such that a spent electron beam in the collector collides against a water-cooled part of the collector.

3. The large electron tube as set forth in claim 1, further comprising a sweep mechanism that sweeps a line of magnetic force in the collector.

4. The large electron tube as set forth in claim 1, wherein the magnetic body is a plate-like magnetic body disposed along an outer side surface of the collector and covering not more than ½ of an outer circumference of the collector.

5. The large electron tube as set forth in claim 1, wherein the collector has a resonant frequency satisfying a condition for electron cyclotron resonance.

6. The large electron tube as set forth in claim 1, further comprising a magnetron injection electron gun that generates a hollow electron beam.

7. The large electron tube as set forth in claim 1, wherein the magnetic body is an iron plate.

8. The large electron tube as set forth in claim 1, wherein the large electron tube is a gyrotron.

9. The large electron tube as set forth in claim 1, wherein the large electron tube is a klystron.

10. A magnetic body to be mounted to a large electron tube, the large electron tube including a collector that is tubular,
the magnetic body, when mounted outside the collector, having no axial symmetry with respect to a center axis of the collector.

11. A method for using a large electron tube, the large electron tube including a collector that is tubular, the method comprising the step of: spreading a spent electron beam in the collector in an asymmetrical manner.

12. The method as set forth in claim 11, further comprising the step of: changing a ratio at which a magnetic body plate, which is disposed outside the collector and has no axial symmetry with respect to a center axis of the collector, covers an outer circumference of the collector by changing the magnetic body plate to a magnetic body plate having a size different from that of said magnetic body plate.

13. The method as set forth in claim 11, further comprising the step of: changing the number of magnetic body plates to thereby change a ratio at which the magnetic body plates cover an outer circumference of the collector, the magnetic body plates being disposed outside the collector and having no axial symmetry with respect to a center axis of the collector.
